(19) United States
(12) Patent Application Publication
(10) Pub. No.: US 2026/0196780 A1
(43) Pub. Date: Jul. 9, 2026

(54) CABLE ASSEMBLY AND CABLE BYPASS ASSEMBLY HAVING THE SAME AND CABLE CONNECTOR ASSEMBLY

(71) Applicants: FOXCONN (KUNSHAN) COMPUTER CONNECTOR CO., LTD., Kunshan (CN); FOXCONN INTERCONNECT TECHNOLOGY LIMITED, Grand Cayman (KY)

(72) Inventor: Jon Jacoby, San Jose, CA (US)

(21) Appl. No.: 19/012,036

(22) Filed: Jan. 7, 2025

(51) Int. Cl. H01R 13/6592

(52) U.S. Cl. CPC H01R 13/6592

(57) ABSTRACT

A cable assembly includes: plural wafer modules stacked along a first direction, each of the wafer modules including: a first module including a first insulative member and plural first terminals arranged in a row along a second direction perpendicular to the first direction and fixed on the first insulative member; and a second module stacked with the first module along the first direction, the second module including a second insulative member, plural second terminals arranged in a row along the second direction and fixed on the second insulative member, and plural cables connected with the second terminals; and a ground member electrically connected with the plural wafer modules.

### BACKGROUND OF THE INVENTION

### Field of the Invention

The present invention relates generally to a cable assembly, a cable bypass assembly, and a cable connector assembly to transmit high frequency signals.

### Description of Related Arts

U.S. Pat. No. 11,682,865 discloses an electrical connector including a plurality of mating modules, each mating module including a plurality of conductive terminals, each conductive terminal including a tail portion and a mating portion; a first metal shield; a second metal shield; and a cable including a plurality of cores electrically connected to the tail portions. The first metal shield and the second metal shield are located on opposite sides of the conductive terminals. The conductive terminals include differential signal terminals, a first ground terminal, and a second ground terminal. The differential signal terminals are located between the first ground terminal and the second ground terminal. The first metal shield, the second metal shield, the first ground terminal, and the second ground terminal jointly form a shielding space enclosing mating portions of the differential signal terminals.

U.S. Patent Application Publication No. 2023/0396030 discloses a connector assembly including a first connector and a second connector. The second connector and the first connector substantially have same structure and the second connector can be rotated 180 degrees relative to the first connector to mate with the first connector. The first connector includes a housing and a plurality wafers disposed in the housing. The housing has a first engagement feature and a second engagement feature matching with each other. Each wafer includes a plurality of signal terminal pairs, a plurality of cables correspondingly connected to the signal terminal pairs and a plurality of shielding members corresponding to each signal terminal pair. The shielding members are configured to mate with each other when rotated 180 degrees relative to each other.

However, as the signal transmission requirements of high-speed connectors continue to increase, an improved connector design can be provided to make the connector have better electrical performance.

### SUMMARY OF THE INVENTION

A main object of the present invention is to provide a cable assembly having a good electrical performance.

To achieve the above object, a cable assembly comprises: a plurality of wafer modules stacked along a first direction, each of the wafer modules comprising: a first module comprising a first insulative member and a plurality of first terminals arranged in a row along a second direction perpendicular to the first direction and fixed on the first insulative member; and a second module stacked with the first module along the first direction, the second module comprising a second insulative member, a plurality of second terminals arranged in a row along the second direction and fixed on the second insulative member, and a plurality of cables connected with the second terminals; and a ground member electrically connected with the plurality of wafer modules.

To achieve the above-mentioned object, a cable bypass assembly adapted for mating between a mating connector and a chip of a device at a position near the chip comprises: a housing comprising a front side for mating with the mating connector and a rear side opposite to the front side along a first direction; and a cable assembly received in the housing and comprising: a ground member; and a plurality of wafer modules stacked along a second direction perpendicular to the first direction, each of the wafer modules comprising: a first module comprising a plurality of first terminals electrically connected with the ground member, the first terminals arranged in a row along a third direction perpendicular to the first and the second direction; and a second module comprising a plurality of second terminals and a plurality of cables, the second terminals arranged in a row along the third direction, each cable comprising a pair of signal conductors, an insulative layer enclosing the signal conductors, and a ground layer enclosing the insulative layer, the signal conductors and the ground layer having a first end and a second end opposite to the first end for electrically connecting with the chip, and some of the second terminals only connected with the first ends of the signal conductors of the cables and the other of the second terminals electrically connected with the ground member and the first ends of the ground layers of the cables.

To achieve the above-mentioned object, a cable connector assembly comprises: a first cable connector comprising: a first housing comprising a first mating face; and a first cable assembly received in the first housing and comprising: a ground member; a plurality of first modules comprising a plurality of first terminals electrically connected with the ground member; and a plurality of second module comprising a plurality of signal terminals, a plurality of ground terminals, and a plurality of cables, each cable comprising a pair of signal conductors electrically connected with the signal terminals, an insulative layer enclosing the signal conductors, and a ground layer enclosing the insulative layer and electrically connected with the ground terminals; and a second cable connector comprising a second housing having a second mating face configured same as the first mating face and mated with the first mating face by being rotated 180 degrees.

Compared to prior art, the cable assembly comprises a ground member electrically connecting all the first modules and the second modules in order to obtain good electrical performance and is conducive to the transmission of high-frequency signals.

### BRIEF DESCRIPTION OF THE DRAWING

FIG. 1 is a perspective view of a cable connector assembly of the present invention, in which the first cable connector and the second cable connector are matched;

FIG. 2 is another perspective view of the cable connector assembly shown in FIG. 1, in which the first cable connector and the second cable connector are not matched;

FIG. 3 is a perspective view of the first cable connector shown in FIG. 2;

FIG. 4 is an exploded view of the first cable connector shown in FIG. 3;

FIG. 5 is another exploded view of the first cable connector shown in FIG. 4;

FIG. 6 is a further exploded view of the cable assembly shown in FIG. 5;

FIG. 7 is a perspective view of the first module and the second module of the cable assembly shown in FIG. 6;

FIG. 8 is an explode view of the first module shown in FIG. 7;

FIG. 9 is a perspective view of the second module shown in FIG. 7;

FIG. 10 is another perspective view of the second module shown in FIG. 9;

FIG. 11 is an explode view of the second module shown in FIG. 10;

FIG. 12 is a further explode view of the second module shown in FIG. 10, wherein the conductive member, the third insulative member and the cables are removed;

FIG. 13 is a cross-sectional view of the second module shown in FIG. 9 taken along line A-A;

FIG. 14 is a cross-sectional view of the second module shown in FIG. 9 taken along line B-B;

FIG. 15 is a cross-sectional view of the cable connector assembly shown in FIG. 1 taken along line C-C; and

FIG. 16 is a cross-sectional view of the cable connector assembly shown in FIG. 1 taken along line D-D.

### DETAILED DESCRIPTION OF THE PREFERRED EMBODIMENT

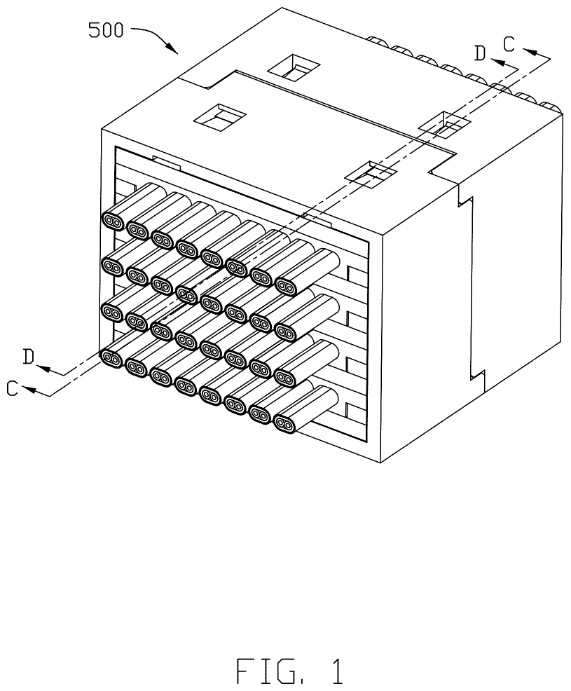

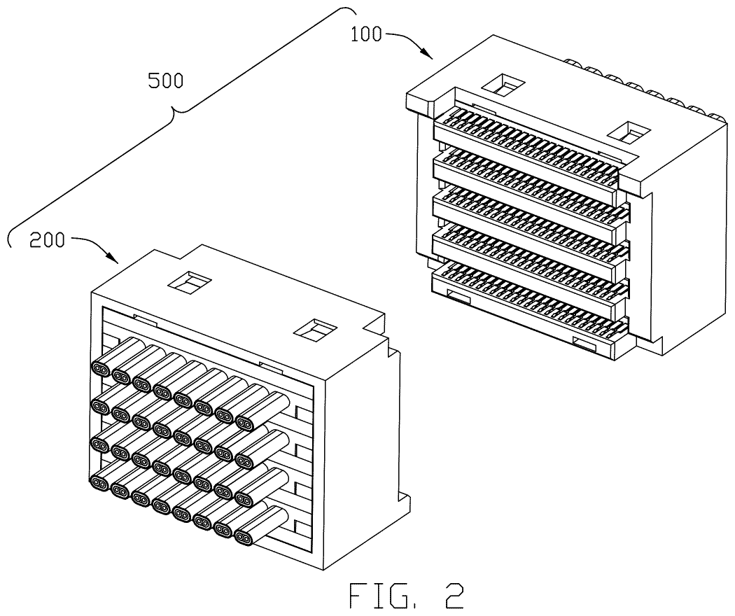

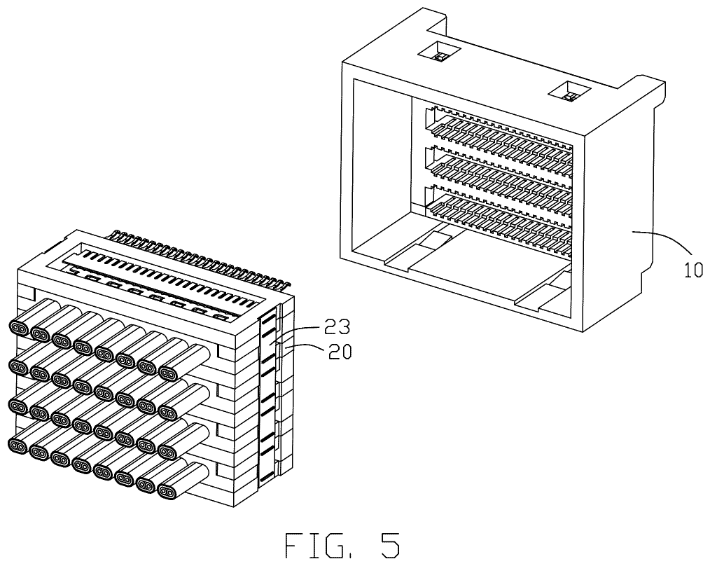

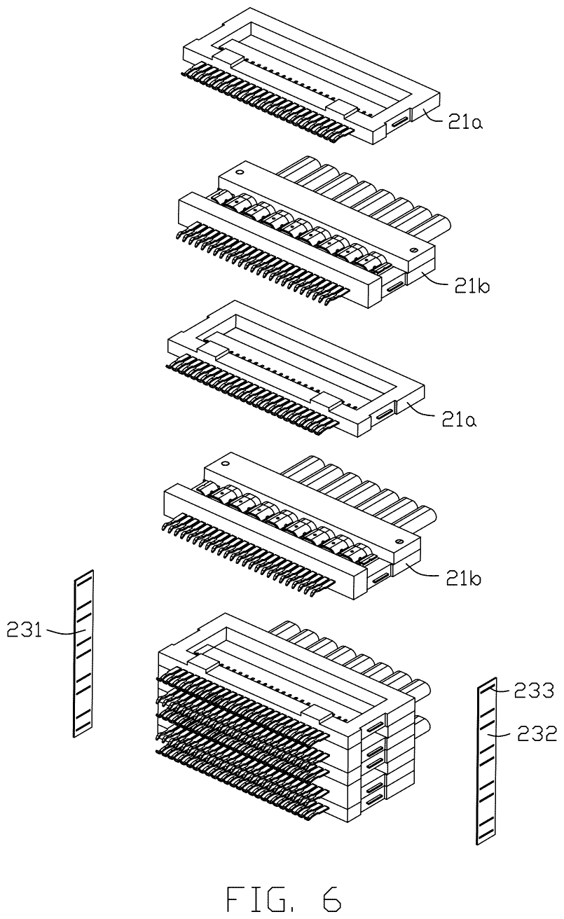

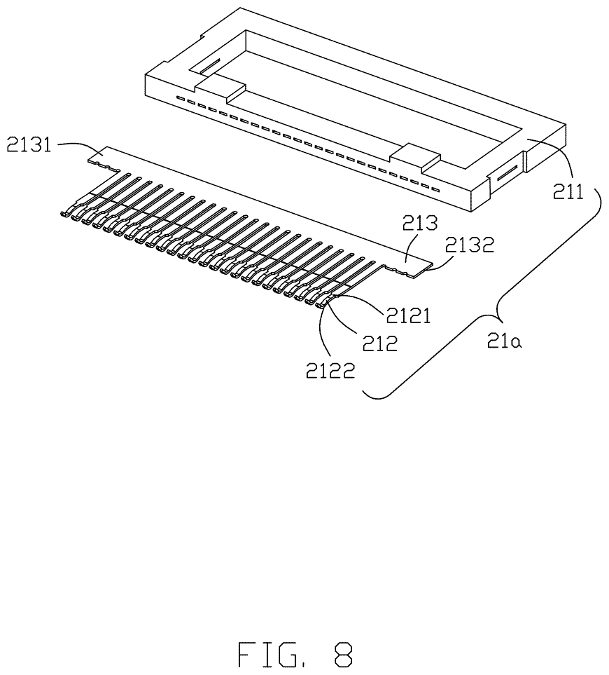

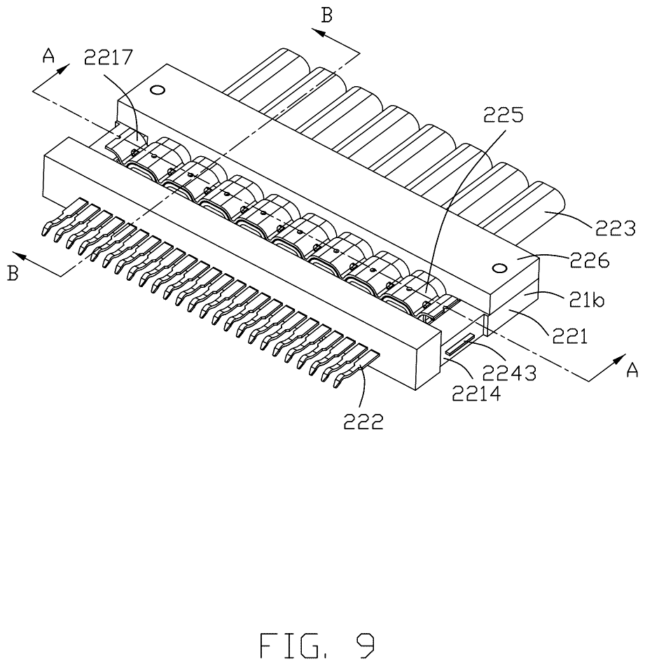

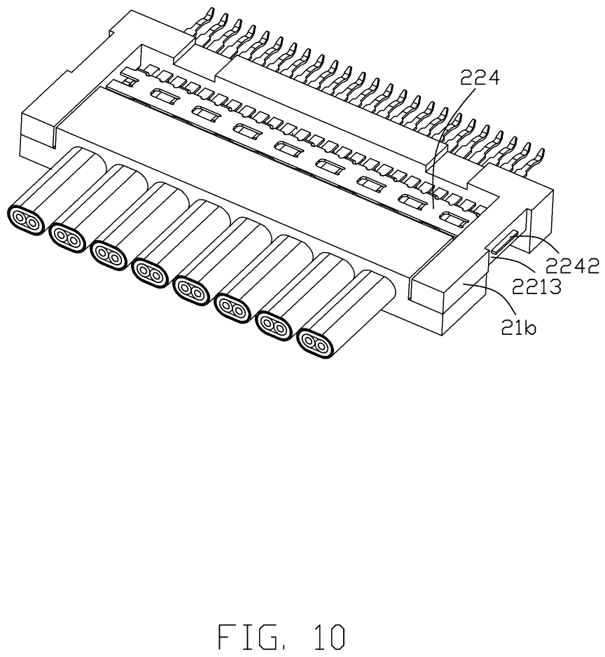

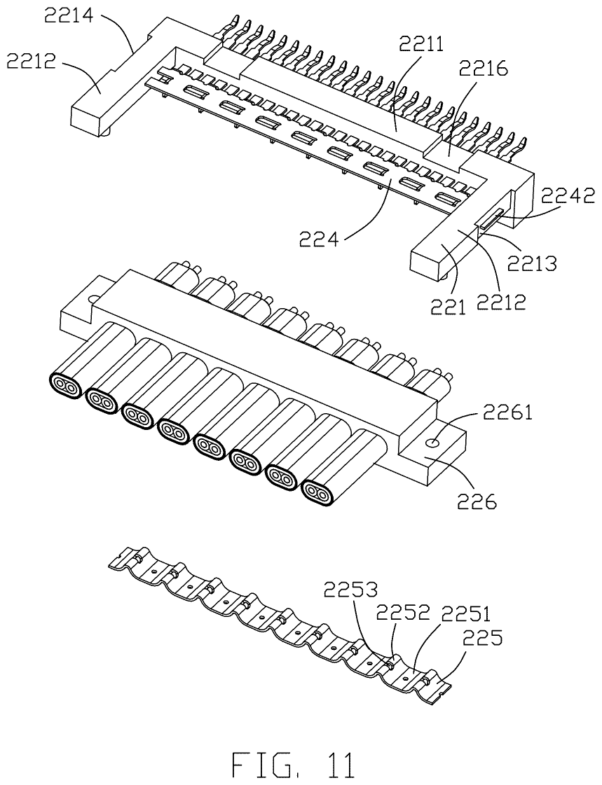

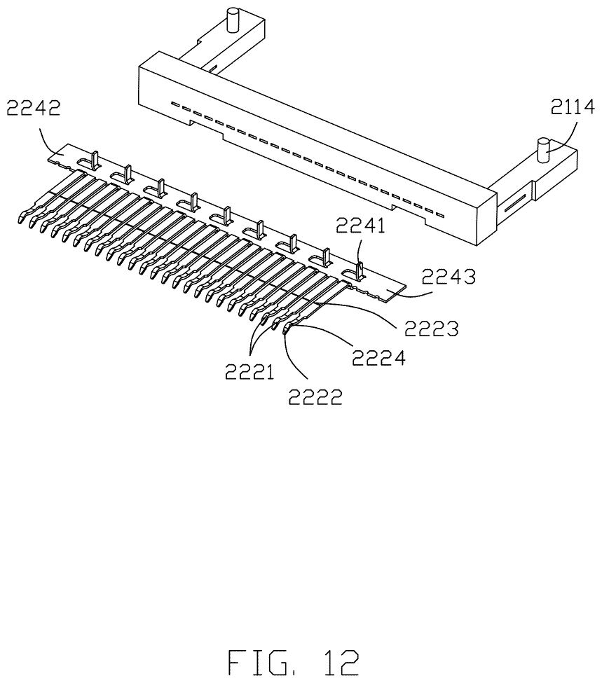

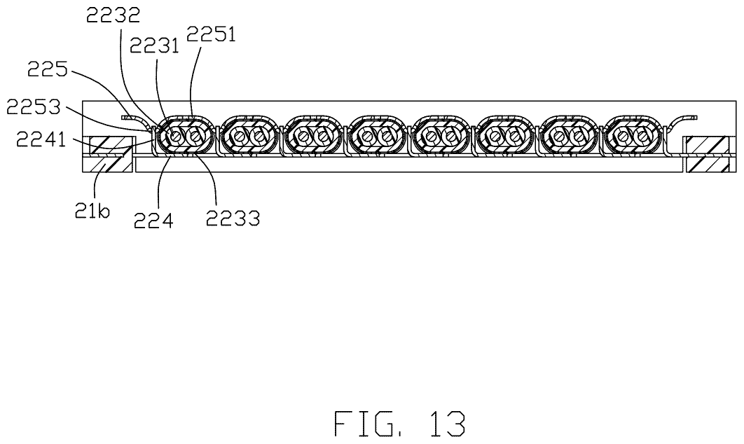

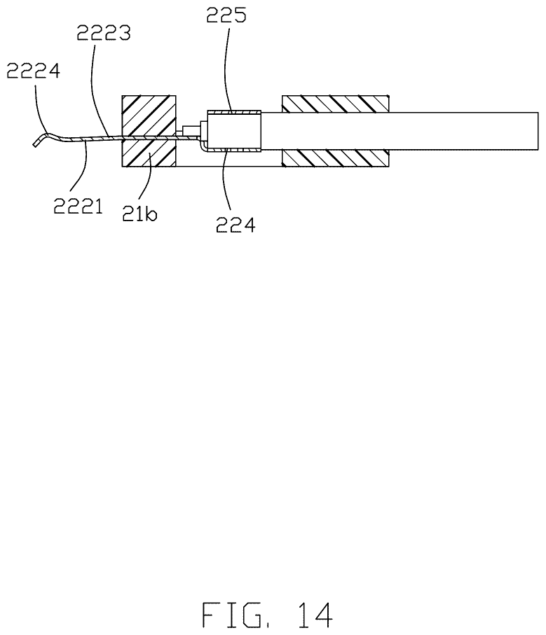

Referring to FIGS. 1-16, a cable connector assembly 500 of the present invention is shown. The cable connector assembly 500 includes a first cable connector 100 and a second cable connector 200. The first cable connector 100 and the second cable connector 200 have the same structure, and one of the first cable connector 100 or the second cable connector 200 can be connected with the other one by rotating 180 degrees. In other embodiments, the first cable connector 100 adapted for being mated or connected between its mating connector and a chip of the device at a position close to the chip.

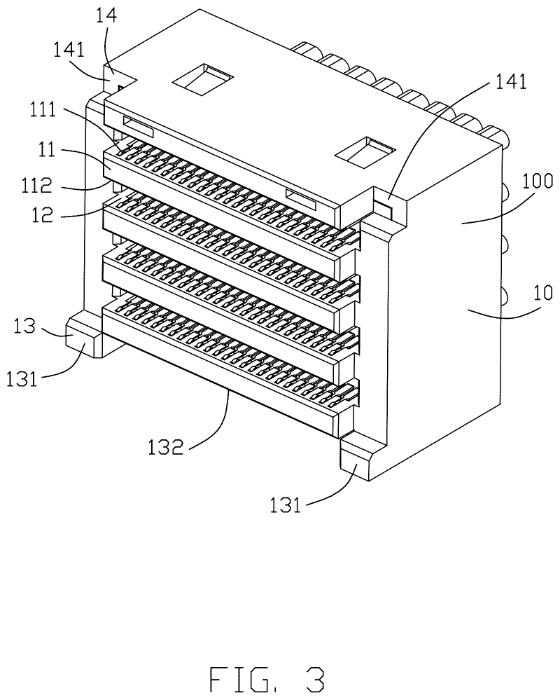

Referring to FIGS. 3-8, the first cable connector 100 includes a housing 10 and a cable assembly 20 received in the housing 10. The cable assembly 20 includes a plurality of wafer modules 21 stacked along a first direction, an outmost wafer module 22, and a ground member 23 connected to each chip modules 21 and the outmost wafer module 22. In this embodiment, the first cable connector 100 includes four wafer modules 21 and one outmost wafer module 22 stacked from top to bottom. Each wafer module 21 includes a first module 21a and a second module stacked up and down with the first module 21a. The outmost wafer module 22 only includes the first module 21a. In this way, each second module 21b is disposed between the two first modules 21a. Each first module 21a includes a first insulative member 211, a plurality of first terminals 212 held by the first insulative member 211, and a first metal plate 213 connecting all the first terminals 212. The plurality of first terminals 212 are arranged in a row along a second direction perpendicular to the first direction. Each first terminal 212 includes a straight first contact portion 2121 and a second contact portion 2122 extending from the first contact portion 2121 to the mating direction and protruding in the first direction. The first insulative member 211 is generally in a rectangular shape and includes a front beam 2111 holding the plurality of first terminals 212, a rear beam 2112 opposite to the front beam 2111, and two side beams 2113 connecting the front beam 2111 and the rear beam 2112. The two side beams 2113 are provided with recesses 2114, 2115 inwardly recessed from the sides. The first metal plate 213 includes a first end 2131 and a second end 2132 respectively extending from the two side beams 2113 and entering the corresponding recesses 2114, 2115. The front beam 2111 is also provided with a protruding portion 2116 mated with the second module 21b.

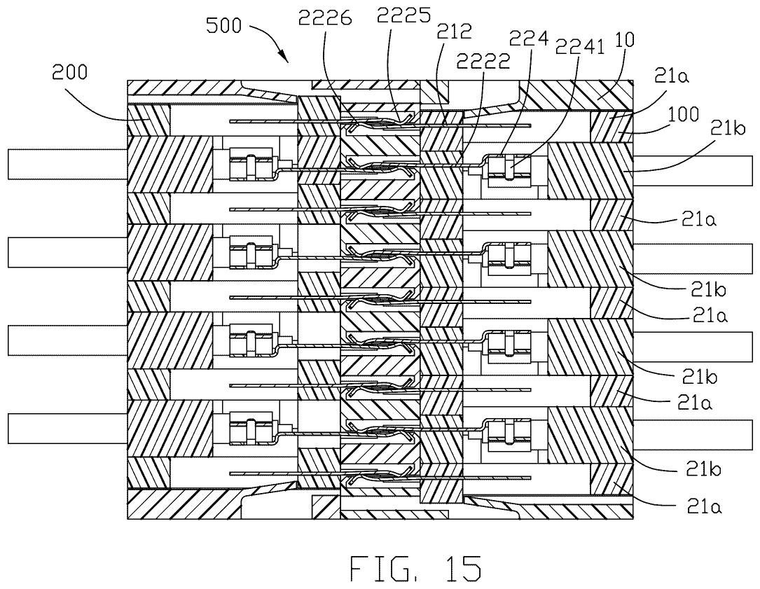

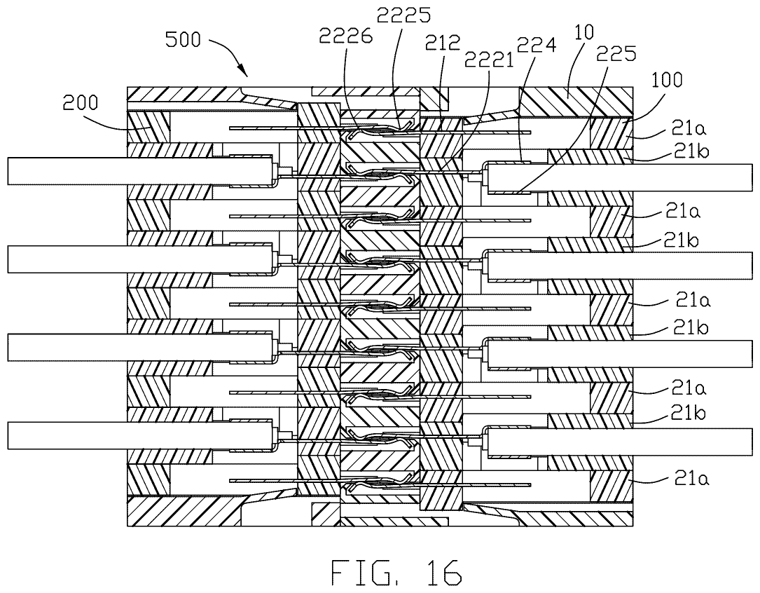

Each second module 21b includes a second insulative member 221, a plurality of second terminals 222 held by the first insulative member 221, and a plurality of cables connected with the second terminals 222. The plurality of second terminals 222 include a plurality of signal terminal pairs 2221 and a plurality of ground terminals 2222, and each signal terminal pair arranged between two ground terminals 2222. The second terminal 222 has the same structure with the first terminal 212. Likewise, each second terminal 222 includes a straight first contact portion 2223 and a second contact portion 2224 extending from the first contact portion 2223 to the mating direction and protruding in the first direction. As shown in FIGS. 15-16, when the first cable connector 100 is mated with the second cable connector 200, the first terminal and the second terminal of the first cable connector 100 are in contact with corresponding first and second terminals of the second cable connector 200 to make a first contact point 2225 and a second contact point 2226.

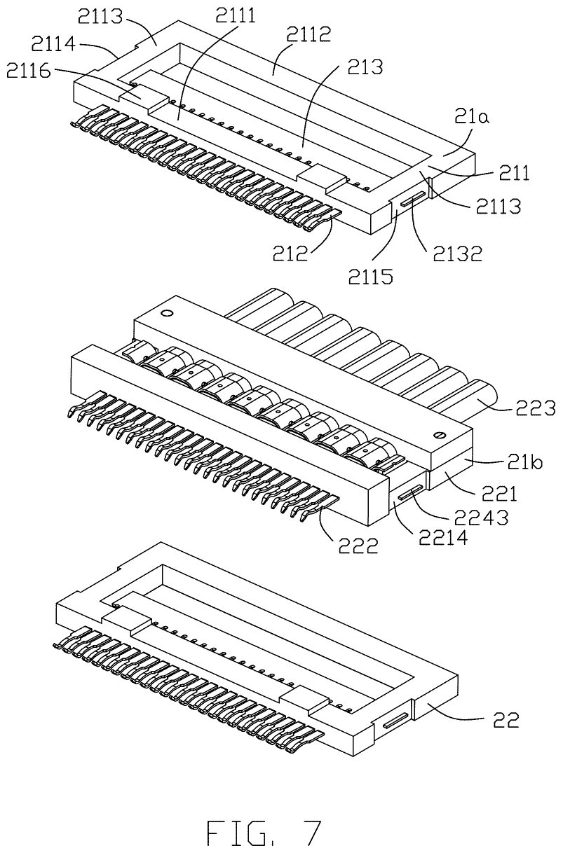

Referring to FIGS. 7 and 9-14, each cable 223 includes a pair of signal conductors 2231 electrically connected to the pair of signal terminals 2221, an insulative layer 2232 covering the signal conductors, and a ground layer 2233 covering the insulative layer. The second module 21b includes a second metal plate 224 and a conductive member 225 respectively provided on the upper and lower sides of each cable 223. The second metal plate 224 connects all the ground terminals 2222. The conductive member 225 includes a plurality of receiving portions 2251 for receiving and contacting one side of the ground layer 2233 of the cable 223, and a plurality of connecting portions connecting each two adjacent receiving portions. Each connecting portion 2252 is provided with a through hole 2253. The second metal plate 224 is in contact with the other side of the ground layer 2233 of the cable 223, and it includes a plurality of tabs extending to the conductive member 225. The conductive member 225 and the second metal plate 224 cooperatively to clamp the cables 223 with each of the cables 223 received in corresponding receiving portion 2251 and each of the tabs inserted into corresponding through hole 2253. In other embodiments, the other free end of the signal conductors and the ground layer not connected to the signal terminal pair and the second metal plate can be electrically connected to the chip of the electronic device.

Each second insulative member 221 includes a base portion 2211 holding the second terminals 222 and two side beams 2212 extending rearwardly from the base 2211. The two side beams 2212 are provided with recesses 2213, 2214 inwardly recessed from the sides. The second metal plate 224 includes a first end 2242 and a second end 2243 respectively extending from the two side beams 2212 and entering the corresponding recesses 2213, 2214. The second module 21b includes a third insulative member 226 holding the cables in a row along the second direction. Each side beam 2212 of the second insulative member 221 is provided with a fixing post 2215, and the third insulative member 226 is provided with a fixing hole 2261 matched with the fixing post 2114. The third insulative member 226 and the second insulative member 221 are assembled together through the cooperation of the fixing posts 2114 and the fixing holes 2261 and are spaced apart from the base portion 2211 to form a receiving space 2217, and the second metal 224 and the conductive member 225 are received in the receiving space 2217. The base portion 2211 of the second insulative member 221 is provided with a receiving groove 2216 matched with the protruding portion 2116 of the front beam 2111 of the first insulative member 211.

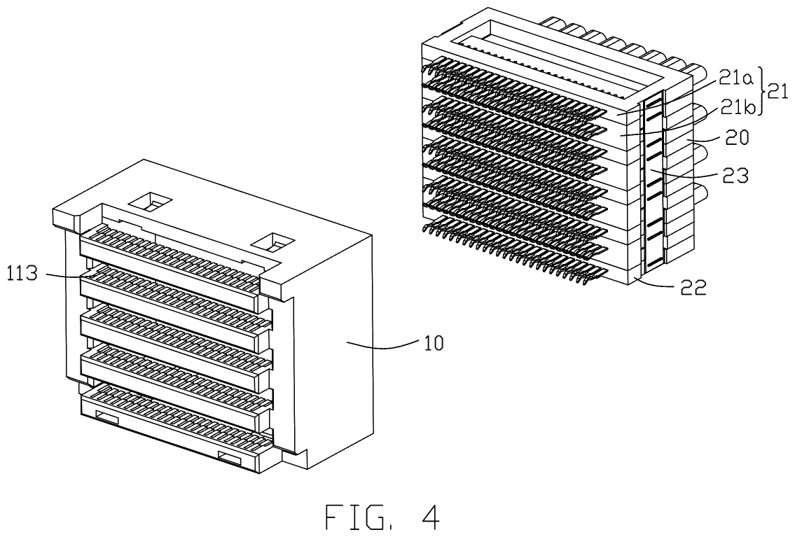

Referring to FIGS. 4-6, the recesses 2114, 2115 on both sides of the first module 21a and the recesses 2213, 2214 on both sides of the second module 21b are aligned. The ground member 23 includes a first ground member 231 received in the recesses 2114, 2213 on one side and a second ground member 232 received in the recesses 2115, 2214 on the other side. The first ground member 231 and the second ground member 232 are each provided with a plurality of through slots 233. The first end 2131 of the first metal plate 213 and the first end 2242 of the second metal plate 224 are engaged with the corresponding through slots 233 of the first ground member 231. The second end 3132 of the first metal plate 213 and the second end 2243 of the second metal plate 224 are engaged with the corresponding through slots 233 of the second ground member 232. The first ground member 231 and the second ground member 232 are both in a long strip shape. The first ground member 231 is electrically connected to all the first metal plates 213 of the first module 21a and the second metal plate 224 of the second module 21b on one side of the cable assembly 20, and the second ground member 232 is electrically connected to all the first metal plates 213 of the first module 21a and the second metal plate 224 of the second module 21b on the other side of the cable assembly 20.

Referring to FIGS. 3-4, the housing 10 includes a plurality of tongue plates 11 extending to the mating direction, and the plurality of tongue plates 11 are spaced apart along the first direction. Each tongue plate 11 includes a top surface 111 and a bottom surface 112 opposite to the top surface 111. The top surface 111 and the bottom surface are all provided with a plurality of terminal slots 113. The first terminals 212 of the first module 21a are disposed in the terminal slots 113 in one of the top surface 111 and the bottom surface 112, and the second terminals 212 of the second module 21b are disposed in the terminal slots 113 in the other of the top surface 111 and the bottom surface 112. Each two adjacent tongue plates 11 forms a mating slot 12 for the corresponding tongue plate of the second cable connector 200 to insert in. The housing 10 includes a mating protrusion 13 provided on one side of the housing 10 along the first direction and a mating recess 14 provided on the other side of the housing 10 opposite to the one side, and the mating protrusion 13 is configured as a structural feature that cooperates with the matching recess 14. The mating protrusion 13 includes a pair of mating posts 13 provided on both sides along the second direction and a receiving recess 132 formed between the pair of the mating posts. The mating recess 14 includes a pair of recesses 141 formed on both sides of the outermost tongue plates 11. When the first cable connector 100 are connected with the second cable connector 200, one of the first cable connector 100 and the second cable connector 200 rotates 180 degrees, then, the housings of the first cable connector 100 and the second cable connector 200 have complementary and adaptable mating surfaces.

1. A cable assembly comprising:
a plurality of wafer modules stacked along a first direction, each of the wafer modules comprising:
a first module comprising a first insulative member and a plurality of first terminals arranged in a row along a second direction perpendicular to the first direction and fixed on the first insulative member; and
a second module stacked with the first module along the first direction, the second module comprising a second insulative member, a plurality of second terminals arranged in a row along the second direction and fixed on the second insulative member, and a plurality of cables connected with the second terminals; and
a ground member electrically connected with the plurality of wafer modules.

2. The cable assembly as claimed in claim 1, wherein each terminal module comprises a first metal plate connecting the plurality of first terminals.

3. The cable assembly as claimed in claim 2, wherein the first metal plate comprises a first end and a second end opposite to the first end, both of the first end and the second end extending beyond a corresponding end of the first insulative member to electrically and mechanical connect with the ground member.

4. The cable assembly as claimed in claim 3, wherein the first insulative member defines a pair of recesses at two ends thereof to receive the first end and the second end of the first metal plate, and the ground member comprises a first ground member received in one of the recesses and a second ground member received in the other recess.

5. The cable assembly as claimed in claim 1, wherein the second terminals comprise a plurality of ground terminals and a plurality of signal terminal pairs, each signal terminal pair disposed between two ground terminals.

6. The cable assembly as claimed in claim 5, wherein each second module comprises a second metal plate connecting the plurality of ground terminals.

7. The cable assembly as claimed in claim 6, wherein each cable comprises a pair of signal conductors electrically connected with the signal terminal pairs, an insulative layer enclosing the signal conductor, and a ground layer enclosing the insulative layer and electrically connecting with the second metal plate.

8. The cable assembly as claimed in claim 7, wherein the second module comprises a conductive member having a plurality of receiving portions for receiving and contacting the ground layer of the cable and a connecting portion connected with two adjacent receiving portions, the connecting portion has a through hole, the second metal plate comprise a plurality of tabs, the conductive member and the second metal plate clamp the cables with each of the cables being received in a corresponding receiving portion, and each of the tabs is inserted into a corresponding through hole.

9. The cable assembly as claimed in claim 8, wherein the second module comprises a third insulative member assembled with the second insulative member, and the cables are fixed by the third insulative member in a row along the second direction.

10. The cable assembly as claimed in claim 9, wherein the second insulative member comprises a base portion extending along the second direction and a pair of beams extending rearwardly from an end of the base portion, the third insulative member assembled on the beams and spaced apart a distance from the base portion to form a receiving space, the second metal plate and the conductive member received in the receiving space.

11. The cable assembly as claimed in claim 1, wherein the pair of beams is provided with recesses, and both ends of the second metal plate are respectively received in corresponding recesses to be mechanically and electrically connected with the ground member.

12. The cable assembly as claimed in claim 1, wherein one of the first insulative member and the second insulative member comprises a projection portion and the other of the first insulative member and the second insulative member defines a receiving recess to mate with the projection portion.

13. The cable assembly as claimed in claim 1, further comprising an outmost first module.

14. A cable bypass assembly adapted for mating between a mating connector and a chip of a device at a position near the chip, the cable bypass assembly comprising:
a housing comprising a front side for mating with the mating connector and a rear side opposite to the front side along a first direction; and
a cable assembly received in the housing and comprising:
a ground member; and
a plurality of wafer modules stacked along a second direction perpendicular to the first direction, each of the wafer modules comprising:
a first module comprising a plurality of first terminals electrically connected with the ground member, the first terminals arranged in a row along a third direction perpendicular to the first and the second direction; and
a second module comprising a plurality of second terminals and a plurality of cables, the second terminals arranged in a row along the third direction, each cable comprising a pair of signal conductors, an insulative layer enclosing the signal conductors, and a ground layer enclosing the insulative layer, the signal conductors and the ground layer having a first end and a second end opposite to the first end for electrically connecting with the chip, and some of the second terminals only connected with the first ends of the signal conductors of the cables and the other of the second terminals electrically connected with the ground member and the first ends of the ground layers of the cables.

15. The cable bypass assembly as claimed in claim 14, wherein the housing comprises a plurality of tongue plates extending forwardly along the first direction and spaced apart from each other along the second direction and a plurality of mating slots formed between two adjacent tongue plates, the first terminals are disposed at one side of a corresponding tongue plate, and the second terminals are disposed at an opposite side of the corresponding tongue plate.

16. The cable bypass assembly as claimed in claim 14, wherein the housing comprises a mating projection and a mating recess.

17. The cable bypass assembly as claimed in claim 16, wherein the mating projection comprises a pair of mating posts and a receiving recess formed between the posts, the mating recess comprises a pair of recesses formed at two opposite outer sides of one of the tongue plates.

18. A cable connector assembly comprising:
a first cable connector comprising:
a first housing comprising a first mating face; and
a first cable assembly received in the first housing and comprising:
a ground member;
a plurality of first modules comprising a plurality of first terminals electrically connected with the ground member; and
a plurality of second module comprising a plurality of signal terminals, a plurality of ground terminals, and a plurality of cables, each cable comprising a pair of signal conductors electrically connected with the signal terminals, an insulative layer enclosing the signal conductors, and a ground layer enclosing the insulative layer and electrically connected with the ground terminals; and
a second cable connector comprising a second housing having a second mating face configured same as the first mating face and mated with the first mating face by being rotated 180 degrees.

19. The cable connector assembly as claimed in claim 18, wherein each second module is disposed between two first modules.

20. The cable connector assembly as claimed in claim 18, wherein each terminal of the first cable connector and each mating terminal of the second cable connector have two contact points arranged one after the other.
